(19) United States
(12) Patent Application Publication
(10) Pub. No.: US 2025/0122448 A1
(43) Pub. Date: Apr. 17, 2025

(54) Single Dose Disinfectant

(71) Applicant: ARXADA AG, Visp (CH)

(72) Inventors: Marcus Bentley, Monroe Township, NJ (US); Xunan Zhu, Livingston, NJ (US); Xiao Jiang, Montvale, NJ (US)

(21) Appl. No.: 18/834,251

(22) PCT Filed: May 4, 2023
(86) PCT No.: PCT/US2023/020977

§ 371 Date: Jul. 30, 2024

Related U.S. Application Data
(60) Provisional application No. 63/340,787, filed on May 11, 2022.

(51) Int. Cl. C11D 3/48; C11D 1/12; C11D 1/86; C11D 3/14; C11D 3/20; C11D 17/04

(52) U.S. Cl. CPC C11D 3/48; C11D 1/12; C11D 1/86; C11D 3/14; C11D 3/2086; C11D 17/044

(57) ABSTRACT

Generally, the present disclosure is directed to single dose, or unitary disinfecting concentrates that are stable in a dissolvable container. The disinfecting concentrate includes at least one biodegradable carboxylic acid and at least one anionic surfactant, and is stable for at least one week at 54° C. as measured according to EPA storage stability test protocol (830.6317). While exhibiting good stability, the disinfecting concentrate is also able to dissolve quickly in water, and, once diluted, exhibits a micro efficacy against Pseudomonas aeruginosa, Staphylococcus aureus, or both Pseudomonas aeruginosa, Staphylococcus aureus at 3 minute contact time according to

### RELATED APPLICATIONS

The present application is based on and claims priority to U.S. Provisional Application Ser. No. 63/340,787 filed on May 11, 2022 which are incorporated herein by reference.

### BACKGROUND

Sanitization and/or disinfection is required in many industries including in the homes of consumers, because of both regulatory and safety concerns. Disinfectant formulations have been developed over the last several decades to reduce or destroy pathogenic organisms such as bacteria, fungi, and viruses. There has been a particular focus on hard surfaces, including floors, walls, countertops, windows, windowsills, sinks, faucets, waste containers, appliances, and cabinet surfaces, as any hard surface can become contaminated, and are often used for food preparation or medical services. Disinfectants have been developed to treat hard surfaces for use in hospitals, rest homes, schools, and homes, however, due to the active ingredients contained in such disinfectants, they are generally packaged in single use, non-biodegradable plastic bottles.

Many different types of sanitizing and/or disinfecting agents have been suggested in the past in formulating disinfectants. For instance, such sanitizing and/or disinfecting agents have included alcohols, chlorine compounds, glutaraldehyde, hydrogen peroxide, iodophors, peracetic acid, phenolics, and quaternary ammonium compounds. However, many of these known sanitizing and/or disinfecting agents, such as quaternary ammonium compounds and halogenated compounds fail to meet current sustainability standards.

Nonetheless, in order to facilitate application, increase the range of activity against different types of microorganisms, or otherwise increase efficacy, the above anti-microbial agents have been used at high concentrations and/or in combination with many other agents, ingredients and components. However, due to the high concentrations necessary to achieve a sanitizing and/or disinfecting composition, and particularly, a concentrate thereof, sanitizing and/or disinfecting agents have proven difficult to stabilize in soluble packaging, such as water-soluble films as well as sachets and/or pods made therefrom. For instance, due to the nature of the sanitizing and/or disinfecting agents, alone or in combination with their concentration, known disinfectant formulations cause the soluble packing to fail prior to meeting necessary shelf life stability, as the active ingredients are incompatible with the films utilized to form the dissolvable or soluble packaging, and begin hydrolysis of the film prior to contact with a solvent.

This poses serious problems for improving the sustainability of sanitizing and/or disinfecting products, as single-use packaging increases shipping and storing costs as well as the energy needed to transport the products. In addition, single-use plastic packaging is generally non-biodegradable, necessitating increased storage for disposal of the single-use packaging, as plastics cannot be degraded in the environment by living organisms. Further, current plastic packing, such as that made by polyethylene terephthalate, which is stable when in contact with known sanitizing and/or disinfecting agents, is not only non-biodegradable, but is also made from non-renewable fossil fuels.

Therefore, it would be a benefit to provide a sanitizing and/or disinfectant composition having improved sustainability. It would also be a benefit to provide a sanitizing and/or disinfectant composition suitable for use in reducing pathogenic organisms on hard surfaces. It would also be a benefit to provide a sanitizing and/or disinfectant composition contained in a solvent-dissolvable container. It would even be a further benefit to provide a sanitizing and/or disinfectant composition in concentrated form contained in a solvent-dissolvable container, such as a water-dissolvable or soluble container.

### SUMMARY

Generally, the present disclosure is directed to a disinfecting concentrate that includes a disinfectant powder disposed in a biodegradable solvent-dissolvable container, which may also be referred to as a water-dissolvable or water-soluble container. The disinfectant powder includes at least one biodegradable carboxylic acid, and at least one anionic surfactant, where the at least one biodegradable carboxylic acid and the at least one anionic surfactant are present in the disinfecting concentrate at a ratio of carboxylic acid to anionic surfactant of about 1:1 or greater on a weight to weight basis. In addition, the biodegradable solvent-dissolvable container is stable for at least one week at 54° C. as measured according to EPA storage stability test protocol (830.6317). Furthermore, in an aspect, the biodegradable solvent-dissolvable container is stable for at least two weeks at 54° C. as measured according to EPA storage stability test protocol (830.6317).

In one aspect, the at least one biodegradable carboxylic acid is a C1-C10 carboxylic acid. Additionally or alternatively, in an aspect, the at least one biodegradable carboxylic acid is citric acid, sorbic acid, acetic acid, boric acid, formic acid, maleic acid, adipic acid, lactic acid, malic acid, malonic acid, glycolic acid, or mixtures thereof. In yet another aspect, the at least one biodegradable carboxylic acid is citric acid or lactic acid, and, in one aspect, the at least one biodegradable carboxylic acid is citric acid.

Moreover, in an aspect, the at least one biodegradable carboxylic acid is coated with a compatibilizing agent. In one aspect, the compatibilizing agent is a salt of a biodegradable carboxylic acid. In another aspect, the compatibilizing agent is a salt of a C1-C10 carboxylic acid. For instance, in yet a further aspect, the compatibilizing agent is a salt of citric acid, sorbic acid, acetic acid, boric acid, formic acid, maleic acid, adipic acid, lactic acid, malic acid, malonic acid, glycolic acid, or mixtures thereof, preferably where the compatibilizing agent is a salt of citric acid, sorbic acid, or combinations thereof.

Nonetheless, in another aspect, the anionic surfactant is a C11-C18 alkyl benzene sulfonate, a C10-C20 branched-chain alkyl sulfate, a C10-C18 alkyl ethoxy sulfate, a mid-chain branched alkyl sulfate, a mid-chain branched alkyl alkoxy sulfate, a C10-C18 alkyl alkoxy carboxylate containing 1-5 ethoxy units, a modified alkylbenzene sulfonate, a C12-C20 methyl ester sulfonate, a C10-C18 alpha-olefin sulfonate, a C6-C20 sulfosuccinate, a fatty methyl ester sulphonate, an alkyl ethyoxy sulphates, an alkyl polyalkoxylated carboxylate, or mixtures thereof. Additionally or alternatively, in one aspect, the at least one anionic surfactant is a sulfate based anionic surfactant, sulfonate based anionic surfactant, or a combination thereof. In another aspect, the at least one anionic surfactant is sodium laureth sulfate, sodium cumenesulfonate, sodium dodecyl benzene sulfonate, sodium coco sulfate, ammonium coco sulfate, sodium lauryl glucoside hydroxypropyl sulfonate, ammonium lauryl glucoside hydroxypropyl sulfonate, sodium decyl glucoside hydroxypropyl sulfonate, ammonium decyl glucoside hydroxypropyl sulfonate or mixtures thereof. In yet a further aspect, the at least one biodegradable carboxylic acid and the at least one anionic surfactant are present in the disinfecting concentrate at a ratio of carboxylic acid to anionic surfactant from about 1:1.1 to about 1:50.

In one aspect, the biodegradable solvent-dissolvable container is formed from polyvinyl alcohol, a cellulose derivative, or combinations thereof. Moreover, in an aspect, the disinfecting concentrate further includes one or more nonionic surfactants, one or more cationic surfactants, or a combination thereof. Further, in one aspect, the disinfecting concentrate further includes a second organic acid, one or more fillers, or a combination thereof. In an aspect, the one or more fillers are sodium sulfate, sodium carbonate, or a combination thereof.

The present disclosure is also generally directed to a disinfectant solution that includes any one or more of the above aspects of a disinfectant solution and a diluent. In one aspect, the disinfecting concentrate is diluted with the diluent at a ratio of disinfecting concentrate to diluent of about 1:8 or greater, preferably from about 1:10 to about 1:100. Additionally or alternatively, in an aspect, the disinfectant solution has a pH of less than 7. Furthermore, in one aspect, the disinfecting solution exhibits a micro efficacy against Pseudomonas aeruginosa and Staphylococcus aureus at 3 minute contact time according to the Germicidal Spray Test method AOAC 961.02. In yet a further aspect, the disinfecting concentrate exhibits a dilution time of about 3 minutes or less.

Other features and aspects of the present disclosure are set forth in greater detail below, and it should be understood that any one or more of the above aspects can be utilized alone or in combination with any of the other aspects noted above or otherwise discussed herein.

### DEFINITIONS

As used herein, the terms “about,” “approximately,” or “generally,” when used to modify a value, indicates that the value can be raised or lowered by 10% and remain within the disclosed aspect, such as 7.5%, such as 5%, such as 4%, such as 3%, such as 2%, such as 1%, or any ranges or values therebetween. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

As used herein, the terms “disinfect” and/or “sanitize” mean the reduction of contaminants and/or pathogenic organisms by about 90% or more, such as about 91% or more, such as about 92% or more, such as about 93% or more, such as about 94% or more, such as about 95% or more, such as about 96% or more, such as about 97% or more, such as about 98% or more, such as about 99% or more, or any ranges or values therebetween, within a 24 hour time period.

As used herein, the term “powder” means free-flowing solid particles. Powder, as used herein should be differentiated from dissolved or suspended solutions of one or more components in a solvent. Thus, in one aspect, it should be understood that “powder” as used herein contains less than about 20% water by weight, such as about 15 wt. % or less, such about 10 wt % or less, such as about 8 wt. % or less, such as about 5 wt. % or less, or any ranges or values therebetween.

### DETAILED DESCRIPTION

It is to be understood by one of ordinary skill in the art that the present discussion is a description of exemplary embodiments only, and is not intended as limiting the broader aspects of the present disclosure

The present disclosure is generally directed to a unit-dose disinfecting concentrate with improved sustainability. Namely, the present disclosure has surprisingly found that a powdered disinfecting concentrate can be formed that is stable in a solvent-dissolvable film container, while still maintaining excellent disinfecting properties, by combining one or more biodegradable carboxylic acids with one or more anionic surfactants at a ratio of the one or more carboxylic acids to the one or more anionic surfactants of 1:1 or greater. For instance, the disinfecting powder of the present disclosure is stable in the solvent-dissolvable carrier (such as a polyvinyl alcohol pouch or pod as will be discussed in greater detail below) for at least about 1 day at 54° C. as measured according to EPA storage stability test protocol (830.6317), such as about 3 days or more, such as about one week or more, such as about ten days or more, such as about two weeks or more, tested at 54° C. and as measured according to EPA storage stability test protocol (830.6317). Thus, unlike previous disinfecting concentrates, the composition of the present disclosure exhibits the necessary stability to be contained in a soluble or dissolvable pod to be considered to be shelf-stable. Thus, the disinfecting concentrate of the present disclosure reduces non-biodegradable packaging and provides a unit dose concentrate than can be added to a solvent/diluent to form a ready-to-use disinfecting solution by an end user.

While displaying excellent stability, the compositions according to the present disclosure also exhibit excellent dilution times, which is the time at which a homogenous or fully dissolved solution, meaning the time at which no visible particles remain in the solution, is obtained from the disinfecting concentrate diluted with a diluent, such as water, of about 30 minutes or less, such as about 20 minutes or less, such as about 15 minutes or less, such as about 10 minutes or less, such as about 5 minutes or less, such as about 3 minutes or less, when dissolved in OECD hard water (375 ppm based upon CaCO3 concentration). Thus, while the disinfecting concentrate exhibits greatly improved stability, the anionic surfactant(s) still allow the one or more carboxylic acids to interact with the diluent to quickly break down the solvent-dissolvable container when placed in a solvent, such as water.

In addition, as noted above, it was surprisingly found that, when any one or more of the above disinfecting concentrates are diluted with a diluent, such as water, the disinfecting solution, in addition to the above reduction of pathogenic organisms or contaminants, can exhibit a micro efficacy against Pseudomonas aeruginosa, Staphylococcus aureus, or both Pseudomonas aeruginosa and Staphylococcus aureus at a 60 minute contact time or less according to the Germicidal Spray Test method AOAC 961.02, such as about 45 minutes or less, such as about 30 minutes or less, such as about 15 minutes or less, such as about 10 minutes or less, such as about 5 minutes or less, such as about 4 minutes or less, such as about a 3 minute or less contact time according to the Germicidal Spray Test method AOAC 961.02.

Nonetheless, as noted above, the disinfecting concentrate is formed from a disinfecting powder that includes at least one biodegradable carboxylic acid. While one having skill in the art may understand that other biodegradable carboxylic acids having disinfecting properties can be used, in one aspect, the carboxylic acid is a C1-C10 carboxylic acid, such as citric acid, sorbic acid, acetic acid, boric acid, formic acid, maleic acid, adipic acid, lactic acid, malic acid, malonic acid, glycolic acid, or mixtures thereof. In one aspect, the at least one biodegradable carboxylic acid is citric acid, lactic acid, or a combination thereof, and, in one aspect, the at least one biodegradable carboxylic acid is citric acid. It should be understood that, in an aspect, any two or more of the above biodegradable carboxylic acids are utilized in the disinfecting powder. However, in an aspect, the disinfecting powder only contains a single acid, such as, in one aspect, citric acid. As may be apparent from the above, in addition, in one aspect, the biodegradable carboxylic acid is present in the composition in the form of a powder.

Furthermore, in one aspect, the present disclosure has unexpectedly found that the stability of the disinfecting concentrate can be further improved by coating the biodegradable carboxylic acid powder particles with a compatibilizing agent. For instance, without wishing to be bound by theory, while the one or more anionic surfactants stabilize the one or more biodegradable carboxylic acids, some of the acid may still be capable of hydrolyzing and cross-linking with the solvent-soluble container. Thus, in one aspect, a compatibilizing agent can be used to coat the one or more carboxylic acids to further prevent hydrolyzing and cross-linking with the solvent-dissolvable container. The compatibilizing can be a salt of a biodegradable carboxylic acid, such as salt of a C1-C10 carboxylic acid. In an aspect, the compatibilizing agent is a salt of citric acid, sorbic acid, acetic acid, boric acid, formic acid, maleic acid, adipic acid, lactic acid, malic acid, malonic acid, glycolic acid, or mixtures thereof, preferably where the compatibilizing agent is a salt of citric acid, sorbic acid, or combinations thereof. Further, in an aspect, the compatibilizing agent can be a salt of the biodegradable carboxylic acid(s) present in the disinfecting concentrate (e.g. citric acid coated with sodium citrate).

Regardless of the carboxylic acid(s) selected, alone or including the one or more compatibilizing agents selected, the one or more biodegradable carboxylic acid(s) may be present in the concentrate in an amount from about 10% to about 90% by weight, such as about 10% to about 50% by weight, such as about 15% to about 49%, such as about 20% to about 48%, such as about 25% to about 47%, such as about 30% to about 46%, such as about 35% to about 45%, or any ranges or values therebetween. Thus, the above weight percentages can refer to the carboxylic acid alone, or the combined weight of the one or more carboxylic acid(s) including the compatibilizing agent coating. Nonetheless, as will be discussed in greater detail below, when the weight percentage includes the compatibilizing agent, the one or more carboxylic acids are still present in an amount sufficient to provide the disinfecting amounts. However, in one aspect, the above weight percentages refer to the amount of active ingredient (e.g. one or more carboxylic acids) present in the disinfecting concentrate.

Surprisingly, a disinfecting concentrate formulated in accordance with the present disclosure can be essentially free or completely free of quaternary ammonium compounds, as well as other non-biodegradable disinfecting agents, including halogenated compounds, such as sodium hypochlorite, and biocidal metals. As used herein, a quaternary ammonium compound is defined as a nitrogen bonded to 4 groups, where none of the groups is an oxygen. For example, a quaternary ammonium compound can be bonded to four groups that are independently alkyl or aromatic carbon chains. The carbon chains can be substituted with a halogen, an alcohol, or other chemical groups; however, the carbon chains should not include another ionizable group (i.e., the quaternary ammonium group is the sole ionizable group). However, these compounds are not biodegradable, and also lead to failure of the solvent-dissolvable container without reaching necessary shelf-life.

Additionally, or alternatively, a disinfecting concentrate formulated in accordance with the disclosure can be essentially free of a short chain alcohol (e.g., a C1-C5 mono-alcohol or diol). As used herein a short chain alcohol is defined as an organic compound including an alcohol (C—OH) moiety that has a boiling point of less than about 140° C. at standard temperature and pressure. Example short chain alcohols include: methanol, ethanol, propanol, isopropanol, butanol, pentanol, and isoamyl alcohol.

Nonetheless, in one aspect, the disinfecting concentrate according to the present disclosure may not include any other disinfecting actives other than the one or more biodegradable carboxylic acid(s).

Regardless of the one or more biodegradable carboxylic acids selected, the powdered disinfecting concentrate also includes one or more anionic surfactants. In one aspect, the anionic surfactant is a C11-C18 alkyl benzene sulfonate, a C10-C20 branched-chain alkyl sulfate, a C10-C18 alkyl ethoxy sulfate, a mid-chain branched alkyl sulfate, a mid-chain branched alkyl alkoxy sulfate, a C10-C18 alkyl alkoxy carboxylate containing 1-5 ethoxy units, a modified alkylbenzene sulfonate, a C12-C20 methyl ester sulfonate, a C10-C18 alpha-olefin sulfonate, a C6-C20 sulfosuccinate, a fatty methyl ester sulphonate, an alkyl ethyoxy sulphate, an alkyl polyalkoxylated carboxylate, or mixtures thereof. Furthermore, in one aspect, the at least one anionic surfactant is a sulfate based anionic surfactant, sulfonate based anionic surfactant, or a combination thereof.

In one aspect, the at least one anionic surfactant is sodium laureth sulfate, sodium lauryl sulfate, sodium cumenesulfonate, sodium dodecyl benzene sulfonate, sodium coco sulfate, ammonium coco sulfate, sodium lauryl glucoside hydroxypropyl sulfonate, ammonium lauryl glucoside hydroxypropyl sulfonate, sodium decyl glucoside hydroxypropyl sulfonate, ammonium decyl glucoside hydroxypropyl sulfonate or mixtures thereof. While any one or more of the above anionic surfactants may be used in accordance with the present disclosure, in an aspect, the one or more anionic surfactants includes a blend of at least one sulfate based anionic surfactant and at least one sulfonate based anionic surfactant.

For instance, in one aspect, the one or more anionic surfactants can include a blend of at least one sulfate based anionic surfactant and at least one sulfonate based anionic surfactant at a ratio of the at least one sulfate based anionic surfactant to the at least one sulfonate based anionic surfactant of 1:1 or greater, such as about 1:1.1 or greater, such as about 1:1.2 or greater, or any ranges or values therebetween. Of course, such ratios can be in regards to one sulfate or sulfonate, or can refer to a total amount of two or more sulfates or sulfonates.

Regardless of the one or more anionic surfactant(s) selected, the one or more anionic surfactant(s) can be present in the concentrate in an amount from about 20% to about 90% by weight, such as about 30% to about 85%, such as about 35% to about 80%, such as about 40% to about 75%, such as about 45% to about 70%, such as about 50% to about 65%, or any ranges or values therebetween.

However, as noted above, it should be understood that the present disclosure is directed to a disinfectant/sanitizing agent. Therefore, in one aspect, the one or more anionic surfactants are selected to have little to no foaming properties, unlike anionic surfactants selected for soaps, detergents, and other foaming personal care applications. In addition, in one aspect, the anionic surfactant does not include substantially any acids, and, in an aspect, is free of acids of anionic surfactants.

Notwithstanding the amount of the one or more anionic surfactant(s) and biodegradable carboxylic acid(s) contained in the disinfecting concentrate, as noted above, the present disclosure has surprisingly found that by carefully controlling the ratio of the at least one biodegradable carboxylic acid and the at least one anionic surfactant, a concentrate with improved stability can be formulated. Thus, in one aspect, the at least one biodegradable carboxylic acid and the at least one anionic surfactant are present in the disinfecting concentrate at a ratio of carboxylic acid to anionic surfactant of about 1:1 or greater, such as about 1:1.1 or greater, such as about 1:1.2 or greater, such as about 1:1.3 or greater, such as about 1:1.4 or greater, such as about 1:1.5 or greater up to about 1:50 or less, such as about 1:45 or less, such as about 1:40 or less, such as about 1:30 or less, such as about 1:25 or less, such as about 1:20 or less, such as about 1:15 or less, such as about 1:10 or less, or any ranges or values therebetween.

Regardless of the at least one biodegradable carboxylic acid and the at least one anionic surfactant selected, the disinfectant concentrate can include one or more surfactants, fillers, and other inert ingredients, such as fragrances, dyes, dispersants, chelating agents, stabilizers, and the like, so long as they do not act to hydrolyze or destabilize the solvent-dissolvable container.

In one aspect, the disinfectant concentrate can include one or more nonionic surfactants, such as alkoxylated alcohols, fatty alcohols, glycol ethers, alkyl polyglucosides, phenol ethers, glycerol esters, fatty acid esters, amine oxides, alkylene glycols, and combinations thereof. For instance, in one aspect, the nonionic surfactant can include a polyoxyethylene glycol alkyl ether, an octaethylene glycol monododecyl ether, a pentaethylene glycol monododecyl ether, a polyoxypropylene glycol alkyl ether, an alkyl polyglucoside, glucoside alkyl ethers, decyl glucoside, lauryl glucoside, octyl glucoside, a polyoxyethylene glycol octylphenol ether, a polyoxyethylene glycol alkylphenol ether, a glycerol alkyl ester, a polyglycerol ester, glyceryl laurate, a polyoxyethylene glycol sorbitan alkyl ester, a sorbitan alkyl ester, dodecyldimethylamine oxide, block copolymers of polyethylene glycol and polypropylene glycol, poloxamers and polyethoxylated tallow amine (POEA), and mixtures thereof.

When present, the one or more nonionic surfactants can be present in the disinfecting concentrate in an amount of about 10% or less by weight of the disinfecting concentrate, such as about 9% or less, such as about 8% or less, such as about 7% or less, such as about 6% or less, such as about 5% or less, such as about 4% or less, such as about 3% or less, such as about 2% or less, such as about 1% or more, or any ranges or values therebetween.

The disinfectant concentrate can also include one or more non-quaternary ammonium (quat) cationic surfactants. For instance, in one aspect, the non-quaternary ammonium cationic surfactant is a primary, secondary, and/or tertiary amine, such as one or more C8-C22 primary, secondary, and/or tertiary amines.

When present, the one or more cationic surfactant(s) can be present in the disinfecting concentrate in an amount of about 10% or less by weight of the disinfecting concentrate, such as about 9% or less, such as about 8% or less, such as about 7% or less, such as about 6% or less, such as about 5% or less, such as about 4% or less, such as about 3% or less, such as about 2% or less, such as about 1% or more, or any ranges or values therebetween.

The disinfectant concentrate can also include one or more fillers. Fillers utilized in the disinfecting concentrate can include inorganic salts of sulfate, carbonate, and chloride anions. In one aspect, fillers can include lithium, sodium, potassium, magnesium and calcium salts of sulfate, carbonate, and chloride anions.

When present, the one or more fillers can be present in the disinfecting concentrate in an amount of about 1% to about 90% by weight of the disinfecting concentrate, such as about 2.5% to about 80% by weight, such as about 5% to about 70% by weight, such as about 7.5% to about 60% by weight, such as about 10% to about 50% by weight, or any ranges or values therebetween.

Notwithstanding the final formulation of the disinfectant powder, the disinfectant powder of the present disclosure is disposed within a solvent-dissolvable container. In one aspect, the solvent dissolvable container(s) containing the powdered disinfectant do not require further individual packaging due to the improved stability of the concentrate of the present disclosure. Nonetheless, in one aspect, two or more of the solvent-dissolvable containers of the present disclosure may be disposed in packaging that prevents premature contact with the disinfecting concentrate and water, such as an overpack container as known in the art. However, as noted, it should be understood that such a packaging contains a plurality of the solvent-dissolvable containers of the present disclosure, and does not include non-dissolvable packaging for each unit-dose.

Nonetheless, in one aspect, the solvent-dissolvable container is formed from one or more films formed of: a polyvinyl alcohol (PVA), a polyalkylene oxide, a cellulose or derivative thereof, a cellulose ether, a cellulose ester, a cellulose amide, a polyvinyl acetate, polysaccharides, including starch and gelatin, natural gums such as xanthum and carragum, glycerine, chitosan, a modified starch, and combinations thereof. In one aspect, the biodegradable solvent-dissolvable container is formed from polyvinyl alcohol, a cellulose derivative, or a combination thereof.

In one aspect, the solvent-dissolvable container contains a polyvinyl alcohol in an amount of at least 60% by weight of the container (prior to the inclusion of the disinfectant powder), such as about 70% or more, such as about 80% or more, such as about 90% or more, such as up to 100% by weight based upon the weight of the empty container. In one aspect, the film is crosslinked to increase strength and flexibility of the film. However, as noted above, crosslinking and any other additives should maintain the biodegradability of the solvent-dissolvable container, and should not slow hinder the dissolution of the disinfecting concentrate once submerged in a solvent, such as water.

After formation of the water-soluble film, the disinfectant powder may be prepared by preparing the disinfecting powder, and sealing a portion of the disinfecting powder within a container, such as a pouch, pod, or packet formed by a water soluble film as discussed above, such as a polyvinyl alcohol film or other biodegradable water soluble polymer film. Preparing the disinfecting powder may include combining one or more of the components of the concentrated disinfecting powder and mixing the combined components to produce a disinfecting powder. The container(s) containing the disinfecting powder are then sealed by any known machine and/or technique.

Each of the unit dose disinfecting concentrate(s) can include an amount of active ingredient sufficient to yield the above discussed disinfecting properties in combination with an amount of anionic surfactant(s) sufficient to stabilizing the one or more biodegradable carboxylic acids. Thus, as one having skill in the art would understand that various amounts may be used based upon the final dilution to yield final concentrations of 100 ppm to about 12,000 ppm of the active upon dilution, such as about 1,000 ppm to about 11,000 ppm, such as about 2,500 ppm to about 10,000 ppm, such as about 4,000 ppm to about 9,000 ppm, or any ranges or values therebetween. While the unit dosage containers can be formed into a variety of shapes and sizes, in one aspect, the unit dosage container can have a generally square or rectangular cross-section, or instead may be formed as a long cylindrical cross section in order to facilitate use with bottle.

As discussed above, the disinfecting concentrate according to the present disclosure is a unit dosage, meaning that each water-dissolvable container contains an amount of the disinfecting powder sufficient to provide the above disinfecting/sanitizing effects when diluted with water or another suitable solvent. In one aspect, each water-dissolvable container can be diluted with a diluent at a ratio of the disinfecting concentrate to diluent of about 1:8 or greater, such as about 1:9 or greater, such as about 1:10 or greater, such as about 1:11 or greater, such as about 1:12 or greater, such as about 1:13 or greater, such as about 1:14 or greater, up to about 1:100 or less, such as about 1:90 or less, such as about 1:80 or less, such as about 1:70 or less, or any ranges or values therebetween.

Once diluted, the disinfecting solution has an acidic pH of about 7 or less, such as about 6.5 or less, such as about 6 or less, such as about 5.5 or less, such as about 5 or less, such as about 4.5 or less, such as about 4 or less, such as about 3.5 or less, such as about 1.5 or greater, or any ranges or values therebetween. Namely, without wishing to be bound by theory, it was found that by maintaining an acidic pH, the disinfecting properties of the disinfecting solution may be further improved while still maintaining the stability of the disinfecting concentrate in the solvent-dissolvable container.

Nonetheless, the present disclosure is also generally directed to disinfecting and/or sanitizing a hard surface and/or to clean and/or sterilize instruments. Thus, in one aspect, the disinfectant solution (e.g. after dilution of the disinfecting concentrate) can be delivered to a surface to be cleaned, sanitized or disinfected by conventional methods, such as pouring the composition on a surface; spraying the surface, including but not limited to, pump spray applicators, pressurized spray applicators and the like; a saturated wipe; a rag and a bucket; a mop and bucket; a sponge and a bucket; or via automated cleaning equipment and other similar and conventional ways to apply an anti-microbial or disinfectant composition to a surface for the purposes of sanitizing or disinfecting the surface.

To use the disinfectant solution of the present disclosure, a surface is treated with the substrate by spraying, pouring, wiping, or otherwise applying the disinfecting solution to the surface. Once applied to the surface, the disinfecting solution is allowed to remain on the surface for a period of time. The disinfectant composition may be applied to the surface and allowed to dry or may alternatively be dried by wiping the surface with a dry wipe or wiping device.

Surfaces, which may be disinfected with the disinfectant composition include, but are not limited to, those located in dairies, homes, health care facilities, swimming pools, canneries, food processing plants, restaurants, hospitals, institutions, and industry, including secondary oil recovery. Any suitable hard surface may be treated in accordance with the present disclosure, particularly frequently touched hard surfaces. The hard surface, for instance, can be made from glass, a metal such as an aluminum or stainless steel, a ceramic, a stone such as granite or marble, a plastic or polymer material, or the like. Specific areas targeted for application include hard surfaces in the home such as kitchen countertops, cabinets, appliances, waste cans, laundry areas, garbage pails, bathroom fixtures, toilets, water tanks, faucets, mirrors, vanities, tubs, and showers. The compositions can also be used to sanitize floors, walls, furniture, mirrors, toilet fixtures, windows, and wood surfaces, such as fence rails, porch rails, decks, roofing, siding, window frames, and door frames. The compositions are particularly well suited for application on indirect food contact surfaces, such as cutting boards, utensils, containers, dishes, wash basins, appliances, and countertops. Areas in hospitals would include beds, gurneys, tables, canisters, toilets, waste cans, stands, cabinets, shower stalls, floors, door knobs, bed rails, walls or any other non-porous surface. Particularly, in one aspect, the surface can be an inanimate, non-porous, hard surface in any location.

The following examples are intended to provide a more complete understanding of the present disclosure. The examples are not intended, however, to limit the disclosure.

### Example 1

Samples 1-3 were formed according to Table 1, and placed into a polyvinyl alcohol water-dissolvable container available from Aicello weighing approximately 0.4 grams (e.g. weight of the film prior to inclusion of the sample). Each polyvinyl alcohol water-dissolvable pouch contained approximately 14.2 g of sample.

TABLE 1

| | | Formula A | Formula B | Formula C |
|---|---|---|---|---|
| Trade Name | CAS# | % by wt. | % by wt. | % by wt. |
| Citric Acid | 77-92-9 | 40 | | |
| Coated Citric Acid | 77-92-9; | | 40 | |
| (single coated with | 18996-35-5 | | | |
| monosodium citrate | | | | |
| from 1.5 to 3.5%)* | | | | |
| Double Coated | 77-92-9; | | | |
| Citric Acid (double | 18996-35-5 | | | |
| coated with | | | | 40 |
| monosodium citrate | | | | |
| from 10 to 25%)** | | | | |
| Sodium lauryl | 151-21-3 | 26.7 | 26.7 | 26.7 |
| sulfate | | | | |
| Sodium C14-16 | 68439-57-6; | 13.3 | 13.3 | 13.3 |
| Olefin Sulfonate*** | 1300-72-7 | | | |
| Sodium Dodecyl | 25155-30-0 | 20.0 | 20.0 | 20.0 |
| Benzene Sulfonate | | | | |
| Total: | | 100.00 | 100.00 | 100.00 |

*Available as Citrocoat N from Jungbunzlaur International AG
**Available as Citrocoat N10 from Jungbunzlaur International AG
***Available as BIO-TERGE AS-90 from Stepan

Samples 1-3 were tested for stability according to EPA storage stability test protocol (830.6317), the results of which are illustrated in Table 2 below. After one week and two week stability testing, samples were diluted in 32 ounces of water (e.g. one pod/pouch dissolved in 32 ounces of water) to form a ready-to-use disinfectant solution containing about 6,000 ppm active. The disinfectant solution was then tested against Staphylococcus aureus and Pseudomonas aeruginosa according to the Germicidal Spray Test method AOAC 961.02, the results of which are reproduced in Table 2 below.

TABLE 2

| Measurements | Sample 1 | Sample 2 | Sample 3 |
|---|---|---|---|
| Initial Dilution Time | 3 min | 3 min | 3 min |
| Dissolution Time in | 15 minutes | Fully dissolved | Fully dissolved |
| PVOH FILM | | in 3 minutes. | in 3 minutes. |
| (after 1 wk. at 54° C.) | | | |
| Stability in PVOH | Acceptable | Acceptable | Acceptable |
| FILM (1 wk. at 54° C.) | film | film | film |
| | compatibility | compatibility | compatibility |
| Dissolution Time in | N/A | Fully dissolved | Fully dissolved |
| PVOH FILM | | in 3 minutes | in 3 minutes |
| (after 2 wks. at 54° C.) | | | |
| Stability in PVOH | N/A | Acceptable film | Acceptable film |
| FILM (2 wk. at 54° C.) | | compatibility. | compatibility |
| Germicidal Spray* | N/A | Passed Staph | N/A |
| Products Test (3 min) | | (0/60), Passed | |
| | | Pseudo (0/60) | |

Testing conducted with 375 ppm OECD Hard Water, with soil and 3 minute contact time under non-GLP conditions.
Passing for Staphylococcus aureus and Pseudomonas aeruginosa means no more than 1/60 positive carriers.
N/A in this table were not tested
Acceptable film compatibility was determined based upon no film leakage or breakage or change in film properties as visually measured

As illustrated in Table 2, the disinfecting concentrates according to the present disclosure exhibited excellent shelf stability while maintaining fast dissolution times. In addition, once diluted the disinfecting solutions also exhibited excellent control of Staphylococcus aureus and Pseudomonas aeruginosa according to the Germicidal Spray Test method AOAC 961.02.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims

What is claimed:

1. A disinfecting concentrate comprising:
a disinfectant powder disposed in a biodegradable solvent-dissolvable container;
wherein the disinfectant powder comprises
at least one biodegradable carboxylic acid,
at least one anionic surfactant,
wherein the at least one biodegradable carboxylic acid and the at least one anionic surfactant are present in the disinfecting concentrate at a ratio of the at least one biodegradable carboxylic acid to the at least one anionic surfactant of about 1:1 or greater on a weight to weight basis; and
wherein the biodegradable solvent-dissolvable container is stable for at least one week at 54° C. as measured according to EPA storage stability test protocol (830.6317).

2. The disinfecting concentrate of claim 1, wherein the at least one biodegradable carboxylic acid is a C₁-C₁₀ carboxylic acid.

3. The disinfecting concentrate of claim 1, wherein the at least one biodegradable carboxylic acid is citric acid, sorbic acid, acetic acid, boric acid, formic acid, maleic acid, adipic acid, lactic acid, malic acid, malonic acid, glycolic acid, or mixtures thereof.

4. The disinfecting concentrate of an claim 1, wherein the at least one biodegradable carboxylic acid is citric acid or lactic acid.

5. The disinfecting concentrate of claim 1, wherein the at least one biodegradable carboxylic acid is coated with a compatibilizing agent.

6. The disinfecting concentrate of claim 1, wherein the compatibilizing agent is a salt of a C₁-C₁₀ carboxylic acid.

7. The disinfecting concentrate of claim 1, wherein the compatibilizing agent is a salt of citric acid, sorbic acid, acetic acid, boric acid, formic acid, maleic acid, adipic acid, lactic acid, malic acid, malonic acid, glycolic acid, or mixtures thereof.

8. The disinfecting concentrate of claim 1, wherein the at least one anionic surfactant is a C₁₁-C₁₈ alkyl benzene sulfonate, a branched-chain alkyl sulfate, a C₁₀-C₁₈ alkyl ethoxy sulfate, a mid-chain branched alkyl sulfate, a mid-chain branched alkyl alkoxy sulfate, a C₁₀-C₁₈ alkyl alkoxy carboxylate containing 1-5 ethoxy units, a modified alkylbenzene sulfonate, a C₁₂-C₂₀ methyl ester sulfonate, a C₁₀-C₁₈ alpha-olefin sulfonate, a C₆-C₂₀ sulfosuccinate, a fatty methyl ester sulphonate, an alkyl ethyoxy sulphates, an alkyl polyalkoxylated carboxylate, or mixtures thereof.

9. The disinfecting concentrate of claim 1, wherein the at least one anionic surfactant is a sulfate based anionic surfactant, sulfonate based anionic surfactant, or a combination thereof.

10. The disinfecting concentrate of claim 1, wherein the at least one anionic surfactant is sodium laureth sulfate, sodium cumenesulfonate, sodium dodecyl benzene sulfonate, sodium coco sulfate, ammonium coco sulfate, sodium lauryl glucoside hydroxypropyl sulfonate, ammonium lauryl glucoside hydroxypropyl sulfonate, sodium decyl glucoside hydroxypropyl sulfonate, ammonium decyl glucoside hydroxypropyl sulfonate, or mixtures thereof.

11. The disinfecting concentrate of claim 1, wherein the at least one biodegradable carboxylic acid and the at least one anionic surfactant are present in the disinfecting concentrate at a ratio of carboxylic acid to anionic surfactant from about 1:1.1 to about 1:50.

12. The disinfecting concentrate of claim 1, wherein the biodegradable solvent-dissolvable container is formed from polyvinyl alcohol, a cellulose derivative, or combinations thereof.

13. The disinfecting concentrate of claim 1, further comprising one or more nonionic surfactants, one or more cationic surfactants, or a combination thereof.

14. The disinfecting concentrate of claim 1, further comprising a second organic acid, one or more fillers, or a combination thereof.

15. The disinfecting concentrate of claim 14, wherein the disinfecting concentrate further comprises one or more fillers, optionally wherein the one or more fillers are sodium sulfate, sodium carbonate, or a combination thereof.

16. The disinfecting concentrate of claim 1, wherein the biodegradable solvent-dissolvable container is stable for at least two weeks at 54° C. as measured according to EPA storage stability test protocol (830.6317).

17. A disinfecting solution comprising the disinfecting concentrate of claim 1 and a diluent, optionally wherein the disinfecting concentrate is diluted with the diluent at a ratio of disinfecting concentrate to diluent of about 1:8 or greater.

18. The disinfecting solution of claim 17, wherein the disinfecting solution has a pH of less than 7.

19. The disinfecting solution of claim 18, wherein the disinfecting solution exhibits a micro efficacy against Pseudomonas aeruginosa, Staphylococcus aureus, or both Pseudomonas aeruginosa, Staphylococcus aureus at 3 minute contact time according to the Germicidal Spray Test method AOAC 961.02.

20. The disinfecting solution of claim 17, wherein the disinfecting concentrate exhibits a dilution time of about 3 minutes or less.
